(19) United States
(12) Patent Application Publication
(10) Pub. No.: US 2011/0306714 A1
(43) Pub. Date: Dec. 15, 2011

(54) HEAT-RESISTANT RESIN PRINT COMPOSITION

(75) Inventors: Tomoyuki UEMURA, Saitama (JP); Takeshi SASAKI, Saitama (JP); Takanori OHNUMA, Saitama (JP); Kohei OHARA, Shiga (JP); Yumiko HIKIDA, Shiga (JP); Katsumi MITSUI, Shiga (JP); Takayuki OISHI, Shiga (JP); Eiken KUZUTANI, Shiga (JP)

(73) Assignee: HONDA MOTOR CO., LTD., Tokyo (JP)

(21) Appl. No.: 13/154,794

(22) Filed: Jun. 7, 2011

(30) Foreign Application Priority Data
Jun. 11, 2010 (JP) 2010-133756

(51) Int. Cl. C09D 133/04; C08K 5/053; C09D 175/04

(52) U.S. Cl. 524/388; 524/560; 524/591; 524/386; 524/507; 524/500

(57) ABSTRACT

A resin print composition for imparting a pattern to a fiber product such as a cloth imparts a decorated pattern that hardly generates deformation or discoloration onto the cloth even when pressed in a state to which a high temperature is applied. The resin print composition is made of an aqueous dispersion containing a resin selected from an acrylic resin and a urethane resin, wherein a torque is from 0.085 N·m to 0.315 N·m when a twist is applied at 1°/sec for 60 seconds while pressing at 0.35 MPa under a condition of 170° C. after the aqueous dispersion is brought into a solid state by volatilizing volatile components from the aqueous dispersion.

### BACKGROUND OF THE INVENTION

(1) Field of the Invention

The present invention relates to a resin print composition that can be used for imparting a resin print (decoration pattern) to a fiber product such as a cloth. More particularly, the present invention relates to a resin print composition that hardly generates deformation or discoloration of the pattern even when pressed in a state to which heat is applied.

(2) Description of Related Art

From the past, as an interior decoration sheet for bonding to a seat or a door of an automobile, a cloth (decorated sheet) whose surface is decorated with a resin print composition is widely used. As such a cloth, a polyester cloth is generally used (moquette, tricot, double raschel, jersey, and polyester cloth of fabric structure are prevalent). As a resin print composition, a liquid composition containing a pigment or the like for coloring and using an acrylic resin or a urethane resin as a binder is generally used. The decoration of a cloth is generally carried out by imparting a pattern (line segments, dots, and the like) made of a resin print composition onto one surface of the cloth by the rotary printing method or the roll printing method.

In bonding the aforesaid decorated sheet for interior decoration onto metal parts such as a door or a seat, it is general that the aforesaid decorated sheet is used as it is, or a urethane laminate cloth in which a polyurethane foamed sheet (those having a thickness of 3 mm, 5 mm, and 10 mm are prevalent; these are referred to also as slab urethane) is bonded to a back surface of the decorated sheet is used. A slab urethane is bonded to the back surface of the decorated sheet by press-bonding it onto the decorated sheet while melting a part of the front surface with a flame lamination machine and solidifying the molten front surface by cooling.

A sheet for automobile interior decoration that is produced in this manner is made into a seat cover by cutting and sewing when it is used for a seat, and is let to cover a mold urethane having a chair form. Alternatively, in recent years, due to simplification of the process and an increasing number of seats having a shape that cannot meet by a cut and sewn product, the sheet may sometimes be bonded to a mold urethane having a chair form by using an adhesive agent.

Also, when it is used on an interior wall of the metal parts such as a door, the sheet has been bonded to a polypropylene(PP)-molded door substrate or a board with use of an adhesive agent.

In this manner, by a method conventionally used, a high temperature is not applied to the decorated sheet, so that a heat resistance was not required in the resin print composition.

However, in recent years, for simplification of the production process, a method is studied by which the PP-molding of metal parts of an automobile and the bonding of a decorated sheet are simultaneously carried out. For example, a new process is devised by which a urethane laminate cloth is press-bonded to the door interior wall simultaneously with the resin molding of a door substrate by pressing a metal panel that will be a part of an automobile body and a urethane laminate cloth with a mold while allowing a molten polypropylene resin to flow thereinto (the polypropylene resin intervenes between the metal panel and the urethane laminate cloth).

However, when such a new method is used, the heat of the molten polypropylene resin (170° C. to 200° C.) is conducted to the decorated sheet via the slab urethane, thereby raising a problem in that deformation or discoloration is generated in the decorated part (the pattern formed by the resin print composition) of the sheet surface. In particular, for interior decoration of an automobile, it is general that the interior decoration is unified by using a decorated sheet having the same pattern both on the door and on the seat. When the above new process is used, deformation or discoloration is generated only in the pattern of the door sheet by heating, so that the difference from the pattern of the seat will be conspicuous. Therefore, the new process raises a problem in that the conventional decorated sheet cannot be used as it is.

From the past, improvement of product quality has been studied for a composition that can be used for forming a resin print on a cloth. For example, Japanese Patent Publication No. H04-48832 discloses a water-dispersive covering composition that can form a coating film having durability or an anti-contamination property.

However, even by using these compositions, the problem that is raised in association with the new process, such as deformation or discoloration by high temperature, cannot be solved.

### SUMMARY OF THE INVENTION

Therefore, an object of the present invention is to provide a resin print composition for imparting a pattern to a fiber product such as a cloth that can impart a decoration pattern that hardly generates deformation or discoloration onto the cloth even when pressed in a state to which a high temperature is applied.

As a result of eager studies for solving the aforementioned problems of the prior art, the present inventors have found out that, by using a resin print composition constructed to have a predetermined torque value under a predetermined condition when brought into a solid state made only of non-volatile components by volatilizing the volatile components, the resin print formed on the cloth does not generate deformation or discoloration even when thermally pressed, thereby completing the present invention.

Namely, according to the present invention, there is provided a resin print composition for imparting a pattern to a cloth surface, the resin print composition made of an aqueous dispersion containing a resin selected from the group consisting of an acrylic resin and a urethane resin, wherein a torque is from 0.085 N·m to 0.315 N·m when a twist is applied at 1°/sec for 60 seconds while pressing at 0.35 MPa under a condition of 170° C. after the aqueous dispersion is brought into a solid state by volatilizing volatile components from the aqueous dispersion.

When a cloth surface is decorated by using the resin print composition exhibiting a torque within the above range under the aforementioned condition, a decorated cloth being excellent in texture can be obtained. Also a decorated cloth that does not generate discoloration or deformation in the decorated part (resin print part) when pressed in a state in which a high temperature (170° C. to 200° C.) is applied, can be provided.

When decoration is added on a cloth by using the resin print composition of the present invention, a decorated cloth that does not generate deformation or discoloration in the decorated part even when heated and pressurized can be provided.

### BRIEF DESCRIPTION OF THE DRAWINGS

FIG. 1 is a graph showing transition of the torque when the resin print composition reduced to only non-volatile components is measured with a curastometer;

FIG. 2 is a model view showing a state of pressing using an on-table pressing machine according to Example 4; and

FIGS. 3A and 3B are surface photographs of a decorated cloth after pressing according to Example 4, where FIG. 3A shows a cloth decorated by the resin print composition according to the present invention, and FIG. 3B shows a cloth decorated by the resin print composition of the Comparative Example.

### DETAILED DESCRIPTION OF PREFERRED EMBODIMENTS

As a cloth according to the present invention, a cloth that is generally used as an interior decoration sheet of an automobile can be used. A preferable cloth is a polyester cloth (moquette, tricot, double raschel, jersey, or polyester cloth of fabric structure).

As the resin according to the present invention, a known thermoplastic urethane resin or acrylic resin that is generally used for imparting a resin print (decoration pattern) onto a cloth can be used. For example, an aqueous urethane resin or an aqueous acrylic resin having an ionic property and being dispersed into water even without an emulsifier, or a water-dispersed urethane resin or a water-dispersed acrylic resin that is emulsified and dispersed into water by an emulsifier can be used. The content of the aforesaid resin in the resin print composition as converted in terms of non-volatile components is preferably 70 to 97 wt %, more preferably 80 to 95 wt %.

When an acrylic resin is used as the aforesaid resin, the resin print composition according to the present invention preferably contains 0.5 to 8.0 wt % (more preferably 1.0 to 4.0 wt %) of a cross-linking agent as converted in terms of non-volatile components.

In the present invention, the torque can be measured by a tester (curastometer) and a method according to the die vulcanization test A method (twist vibration type flat plate die vulcanization test) in JIS K6300-2 (method of determining the vulcanization property by the vibration type vulcanization tester). JIS K6300-2 corresponds to ISO-6502. At the time of measurement, the test temperature is set to be 170° C., and a twist is applied at 1°/sec while applying a pressing pressure of 0.35 MPa. Then, the numerical value (torque: unit N·m) is read after 60 seconds. The resin print composition according to the present invention is an aqueous dispersion; however, in measuring the torque, the volatile components are flown away, and the measurement is made in a state in which the resin print composition is reduced to a solid substance made only of non-volatile components.

When a resin print composition having a torque as measured by the above-described method of 0.085 N·m to 0.315 N·m is used, a resin print that can withstand thermal pressing can be formed on a cloth. With a resin print composition having the aforesaid torque of less than 0.085 N·m, deformation or discoloration of the resin print is liable to be generated at the time of thermal pressing. When the above torque exceeds 0.315 N·m, the texture will be inferior when the resin print is formed. A more preferable resin print composition has a torque of 0.10 N·m to 0.28 N·m under the aforementioned condition. A most preferable resin print composition has a torque of 0.17 N·m to 0.25 N·m under the aforementioned condition.

The resin print composition according to the present invention can be used in an already existing method that is used for forming a resin print on a cloth surface. As such a method, the rotary print method and the roll print method are general. In order to prevent clogging of the hole, the resin print composition of the present invention preferably contains a desiccation-preventing agent selected from the group consisting of ethylene glycol, urea, and terpene. The content of the desiccation-preventing agent in the resin print composition as converted in terms of non-volatile components is preferably 2.0 to 8.0 wt %, more preferably 3.0 to 5.0 wt %.

Also, the resin print composition according to the present invention preferably contains a urethane or acrylic thickening agent, and preferably has a viscosity of 5000 to 70000 mPs·S, more preferably 15000 to 50000 mPs·S, when measured at a temperature of 23° C. and a rotation number of rpm by a BH-type viscometer rotor No. 7. When the viscosity is less than 5000 mPs·S, the print will be liable to be blurred. When the viscosity exceeds 70000 mPs·S, the print will be liable to be thinned. The content of the above thickening agent in the resin print composition as converted in terms of non-volatile components is preferably 1.5 to 6.0 wt %, more preferably 2.0 to 4.0 wt %.

Also, the resin print composition according to the present invention preferably contains 1.0 to 15 wt %, more preferably 1.5 to 13.0 wt % of an inorganic pigment as converted in terms of non-volatile components. By using an inorganic pigment, a colored print can be formed on the cloth, and also the viscosity on the print surface can be reduced. This allows that, when the cloth is pressed with a mold, the release from the mold will be smooth, whereby the flatness of the print surface can be maintained.

Next, the present invention will be described in a further more detail with Examples; however, the present invention is by no means limited to the Examples.

### Example 1

### Preparation of Resin Print Composition

A resin print composition was prepared by using a commercially available liquid product containing a base resin in a dispersed state (aqueous emulsion of acrylic resin or aqueous emulsion of urethane resin). The commercially available products used are as follows.

(1) Acrylic Resin
New Coat (manufactured by Shin-Nakamura Chemical Industry Co., Ltd.)
16 (non-volatile components: 50%, solvent: water)
17 (non-volatile components: 50%, solvent: water)
22 (non-volatile components: 50%, solvent: water)

(2) Urethane Resin
Evaphanol (manufactured by Nikka Chemical Co., Ltd.) aqueous polyurethane resin, non-volatile components: 50%, solvent: water
HYDRAN (manufactured by DIC Corporation)

HW-312 (polyether urethane, non-volatile components: 40%, solvent: water)

HW-333 (polyester urethane, non-volatile components: 40%, solvent: water/NMP)

HW-920 (polyester urethane, non-volatile components: 50%, solvent: water)

HW-930 (polyester urethane, non-volatile components: 50%, solvent: water)

HW-940 (polyester urethane, non-volatile components: 50%, solvent: water)

HW-950 (polyether urethane, non-volatile components: 30%, solvent: water)

The above commercially available products (liquid composition containing a base resin in a dispersed state) were used either alone or by mixing these. To 100 parts by weight of the resin-containing liquid composition, were added 2 parts by weight of ethylene glycol as a desiccation-preventing agent, 3 parts by weight of a urethane thickening agent (Neostecker manufactured by Nikka Chemical Co., Ltd., non-volatile components: 50%), and optionally a pigment (titanium oxide) and a cross-linking agent (non-volatile components: 50% for each kind) at the parts by weight shown in Table 1, and the mixture was prepared to have a viscosity of 20000 mPa·S at a temperature of 23° C. and a rotation number of 10 rpm by a B-type viscometer rotor No. 7.

### Example 2

### Measurement of Torque of Resin Print Composition

As a measurement apparatus, a curastometer (type number: Curastometer WR) manufactured by Nichigo Shoji Co., Ltd. (now JSR Trading Co., Ltd.) was used.

After the resin print composition was applied onto a glass substrate and naturally dried for 3 days, the resultant was heated at 100° C. for 10 minutes to volatilize the volatile components completely. The resultant was further heated at 150° C. for 5 minutes (by this heating, those containing a cross-linking agent will finish the cross-linking reaction), so as to prepare a solid substance having a sheet form and made of non-volatile components. The obtained substance was cut and these were superposed on one another to form a test piece having a bulk shape. The amount of the sample was set to be an amount such that a small amount of the test piece would flow out from the whole circumference of the dies when the dies were closed in accordance with the die vulcanization test A method (twist vibration type flat plate die vulcanization test) of JIS K6300-2. Specifically, the fabricated sheet-shaped solid substance was cut into 30 mm×30 mm, and these were superposed on one another so as to have a volume of about 5 cm³ (about 6.5 g), thereby to form a sample. The upper and lower dies were heated to 170° C. in a closed state and, after the temperature was stabilized, the dies were opened. A test piece was mounted on the lower die, and the dies were closed. Thereafter, a twist was added at 1°/sec while applying a pressing-pressure of 0.35 MPa.

FIG. 1 is a graph showing a result of measurement of a plurality of samples (sample nos. 1, 13, 16, and 23). The longitudinal axis represents a torque, and the lateral axis represents a test time. As shown in FIG. 1, the torque fluctuates for several ten seconds after the start of the test; however, the torque is almost stabilized thereafter. In the present Example, the numerical value (unit N·m) was read after 60 seconds.

Here, in order to confirm the reproducibility, an additional test was carried out using a curastometer of a different type number, with a result that almost the same torque was obtained.

### Example 3

### Evaluation of Surface Texture of Resin Print (Before Thermal Pressing)

With use of each resin print composition produced in Example 1, a willow pattern of 1 to 2 mm was printed on a cloth so that about 30 g/m² of the solid component would adhere to the cloth by using a flat screen of 80 mesh and a φ8 mm squeegee, and the resultant was dried at 150° C. for 2 minutes in a drier to form a sample for use.

This sample and a blank sample that has not been subjected to resin printing were mounted on a base, and the sense of touch when each sample was scraped with a finger tip was determined as a texture and evaluated according to the following standard.

| determination of texture | determination result |
|---|---|
| texture does not change at all | ⊙ |
| texture changes little | ◯ |
| texture changes a little | X |
| change in texture is seen easily | X |
| change in texture is considerable | X |

### Example 4

### Method of Evaluation of Deformation and Discoloration by Thermal Pressing of a Resin Print

A semideca processing that presses simultaneously with a steam treatment was carried out on a surface of a polyester raised fabric that has been dyed with a disperse dye and dried, so as to perform processing of laying down the fabric. With use of a resin print composition produced in Example 1, a line pattern with a line width of 1 mm to 2 mm was printed on the fabric by a rotary screen machine, and the resultant was dried at 150° C. for 2 minutes.

In the drying step after resin printing, in the parts other than the resin print, the laid-down fabric by semideca processing will restore into the original pile state, so that a cloth having a concave shape in the line pattern parts and having a convex shape in the other parts was obtained. A slab urethane having a thickness of 5 mm was bonded to the back surface side of the decorated sheet produced in this manner, and this was cut into 50 mm×50 mm for use as a sample.

As a testing apparatus, a small press G-12 type manufactured by Techno Supply Co., Ltd. (trade name: plastic film fabricating apparatus, apparatus name: on-table press) was used.

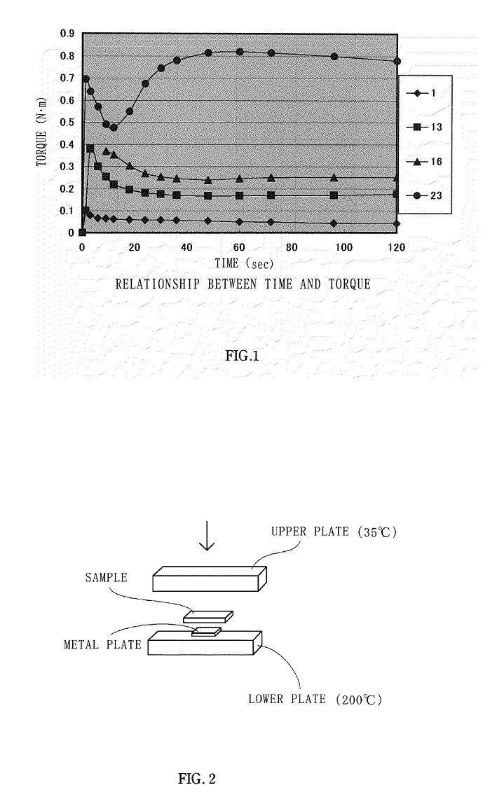

On a lower plate of the pressing machine, a metal plate (S55C) of 30 mm×30 mm×5 mm was put. The temperature of the lower plate was set to be 200° C., and the temperature of the upper plate was set to be 35° C. The sample was mounted with the slab urethane side facing down so as to cover the metal plate, and the sample was pressed by applying a pressure of 140 kg/cm² (See FIG. 2). After pressing for 20 seconds, the sample was taken out, and deformation or discoloration of the resin print (line segments) on the sample surface was confirmed.

This Example assumes a process that performs the PP molding of an automobile door and the bonding of the decorated sheet simultaneously, and is for observing the influence that the heat and the pressure exert on the resin print on the cloth.

Namely, the temperature of the upper plate corresponds to the temperature of the mold on the decorated sheet front surface side (almost equal to ordinary temperature), and the temperature of the metal plate mounted on the lower plate (which is almost equal to the temperature of the lower plate and is almost 200° C.) corresponds to the temperature of the molten polypropylene that is in contact with the back surface side of the decorated sheet. By mounting the sample on a little smaller metal plate and performing pressing, the part of the sample that is in contact with the metal plate is pressed in a state in which the temperature of about 200° C. is applied. However, the part of the sample that is not in contact with the metal plate does not receive heat or pressure, so that comparison between the heat-pressed part and the non-pressed part (blank part) can be made on one sheet of the sample.

### <Determination of Deformation>

After the above heat pressing, the heat-pressed part and the blank part of the sample were compared, and the change in the line segments was determined.

| change in line segments | determination result |
|---|---|
| line segment does not change at all | ⊙ |
| line segment changes little | ◯ |
| line segment changes a little | Δ |
| change in line segment is seen easily | X |
| change in line segment is considerable | X |

### <Determination of Discoloration>

After the above heat pressing, the heat-pressed part and the blank part of the sample were compared, and the change in the color was determined.

| change in color | determination result |
|---|---|
| color does not change at all | ⊙ |
| color changes little | ◯ |
| color changes a little | Δ |
| change in color is seen easily | X |
| change in color is considerable | X |

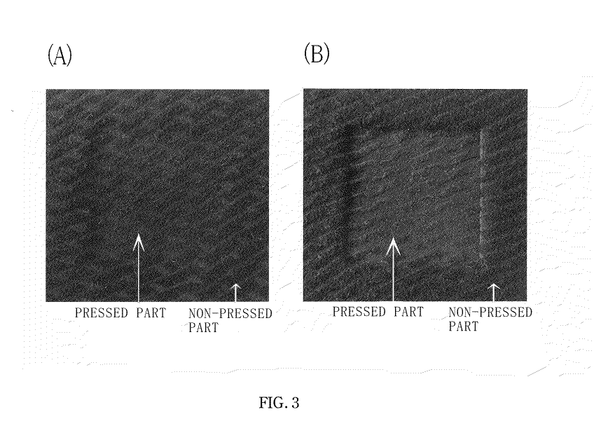

For reference, FIG. 3A shows a photograph of the cloth in which the determination result is good (deformation evaluation ⊙, discoloration evaluation ◯), and FIG. 3B shows a photograph of the cloth in which the determination result is poor (deformation evaluation x, discoloration evaluation x). When the pressed part and the non-pressed part are compared, no change in the shape of the line segment and the color is seen in FIG. 3A. In contrast, in FIG. 3B, breakage of the line segment is clearly seen in the pressed part, and also the color is changed to white-like color.

### Example 5

### Method of Evaluation of the Adhesiveness Of the Surface of the Resin Print

In the above-described process that performs the PP molding of the door and the bonding of the decorated sheet simultaneously, the adhesiveness was measured by the following method with respect to some of the samples in order to determine whether or not there is a problem such that the resin print adheres to the mold and the pattern is deteriorated in releasing from the mold.

A resin print composition was poured onto a resin plate subjected to fluorine treatment, and the resultant was dried in air to fabricate a film having a thickness of 1 mm. After being thermally treated at 150° C. for 1 minute, this film was cut to have a size of 100 mm×100 mm to prepare a sample (by the aforesaid heat treatment, the cross-linking reaction will be completed in the resin print composition containing a cross-linking agent).

The sample film was mounted on a panel heater that is set at 70° C., and the whole circumference was fixed to the panel with an adhesive tape. After the fixation, a metal plate (S55C: 35.5 g) of 30 mm×30 mm×5 mm was put at the center of the sample film, and further a weight of 1 kg load was mounted on the metal plate for pressurization for 1 minute. Thereafter, the metal plate was pulled with use of a tension gauge, and the peeling strength of the metal plate and the sample film was measured. This was shown in N (newton) as an adhesiveness.

The results of Examples 1 to 5 described above will be summarized in Table 1.

TABLE 1

| | base resin | | pigment | desiccation- | | | |
|---|---|---|---|---|---|---|---|
| | dispersion liquid | | titanium | preventing | thickening | | |
| sample | (100 parts) | | oxide | agent | agent | cross-linking agent | |
| number | (kind) | (trade name) | (parts) | (2 parts) | (3 parts) | (kind) | (parts) |
| 1 | acrylic | Newcoat 17 | — | ethylene | Neostecker-N | — | |
| 2 | resin | (N 17) | 0.85 | glycol | | — | |
| 3 | | | 5.2 | | | — | |
| 4 | | | 8 | | | — | |
| 5 | | | — | | | block isocyanate type | 4 |
| | | | | | | (BX) | |
| 6 | | | — | | | ethyleneimine type | 4 |
| | | | | | | (L-100) | |
| 7 | | | — | | | oxazoline type (FX) | 4 |
| 8 | | | — | | | epoxy type (C-60) | 4 |
| 9 | | | — | | | epoxy type (C-60) | 2 |
| 10 | | | — | | | epoxy type (C-60) | 1 |
| 11 | | | — | | | AT (silica) | 6.8 |
| 12 | | Newcoat 16 | — | | | — | |
| 13 | | Newcoat 22 | — | | | — | |
| 14 | | | 0.85 | | | | |
| 15 | | | 8 | | | | |
| 16 | urethane | Evaphanol | — | | | — | |
| 17 | resin | | 8 | | | | |
| 18 | | HW-312 | — | | | — | |
| 19 | | HW-333 | | | | | |
| 20 | | HW-920 | | | | | |
| 21 | | HW-930 | | | | | |
| 22 | | HW-940 | | | | | |
| 23 | | HW-950 | | | | | |
| 24 | | HW-930:HW-920 | — | | | — | |
| | | 60 parts:40 parts | | | | | |
| 25 | acrylic | N-17:HW-930 | — | | | — | |
| | resin + | 40 parts:60 parts | | | | | |
| 26 | urethane | N-17:HW-950 | | | | | |
| | resin | 60 parts:40 parts | | | | | |
| 27 | | N-17:HW-950 | | | | | |
| | | 50 parts:50 parts | | | | | |
| 28 | | N-17:HW-950 | | | | | |
| | | 35 parts:65 parts | | | | | |
| 29 | | N-17:HW-950 | | | | | |
| | | 30 parts:70 parts | | | | | |
| 30 | | N-17:HW-950 | | | | | |
| | | 20 parts:80 parts | | | | | |

| | | result of | change in resin print by | | | |
|---|---|---|---|---|---|---|
| | torque | evaluation | heat pressing | | | |
| | (after | of texture | result of | result of | | |
| sample | 60 s) | of resin | evaluation of | evaluation of | adhesiveness | overall |
| number | (N · m) | print | deformation | discoloration | (N) | evaluation |
| 1 | 0.050 | ◯ | X | X | 8 | X |
| 2 | 0.045 | ◯ | X | X | 1.2 | X |
| 3 | 0.050 | ◯ | X | X | 1.2 | X |
| 4 | 0.050 | ◯ | X | X | 0.9 | X |
| 5 | 0.030 | ◯ | X | X | 1.2 | X |
| 6 | 0.085 | ◯ | Δ-◯ | Δ-◯ | — | ◯ |
| 7 | 0.085 | ◯ | Δ-◯ | Δ-◯ | — | ◯ |
| 8 | 0.195 | ◯ | ⊙ | ◯ | — | ⊙ |
| 9 | 0.104 | ◯ | ◯ | ◯ | — | ◯ |
| 10 | 0.076 | ◯ | X | ◯ | — | X |
| 11 | 0.068 | ◯ | X | ◯ | — | X |
| 12 | 0.076 | ◯ | X | X | — | X |
| 13 | 0.170 | ◯ | ⊙ | ◯ | 1.2 | ⊙ |
| 14 | 0.200 | ◯ | ⊙ | ◯ | 1.2 | ⊙ |
| 15 | 0.200 | ◯ | ⊙ | ◯ | 0.9 | ⊙ |
| 16 | 0.250 | ◯ | ⊙ | ◯ | — | ⊙ |
| 17 | 0.230 | ◯ | ⊙ | ◯ | — | ⊙ |
| 18 | 0.000 | ◯ | X | X | — | X |
| 19 | 0.000 | ◯ | X | X | — | X |
| 20 | 0.050 | ◯ | X | X | — | X |
| 21 | 0.095 | ◯ | ◯ | ◯ | — | ◯ |
| 22 | 0.010 | ◯ | X | X | — | X |
| 23 | 0.820 | X | ◯ | ◯ | — | X |
| 24 | 0.055 | ◯ | X | X | — | X |
| 25 | 0.070 | ◯ | X | X | — | X |
| 26 | 0.115 | ◯ | ◯ | ◯ | — | ◯ |
| 27 | 0.170 | ◯ | ⊙ | ◯ | — | ⊙ |
| 28 | 0.315 | ◯ | ◯ | ◯ | — | ◯ |
| 29 | 0.380 | X | ◯ | ◯ | — | X |
| 30 | 0.485 | X | ◯ | ◯ | — | X |

The parts by weight and the wt % of each component as converted in terms of non-volatile components are shown in Table 2.

TABLE 2

| | parts by weight as converted in terms of | | | | | | wt % as converted in terms of non-volatile | | | | | |
|---|---|---|---|---|---|---|---|---|---|---|---|---|
| | non-volatile components | | | | | | components | | | | | |
| | | | desiccation- | | cross- | | | | desiccation- | | cross- | |
| sample | base | | preventing | thickening | linking | | base | | preventing | thickening | linking | |
| number | resin | pigment | agent | agent | agent | sum | resin | pigment | agent | agent | agent | sum |
| 1 | 50 | 0 | 2 | 1.5 | 0 | 53.5 | 93.5 | 0.0 | 3.7 | 2.8 | 0.0 | 100.0 |
| 2 | 50 | 0.85 | 2 | 1.5 | 0 | 54.35 | 92.0 | 1.6 | 3.7 | 2.8 | 0.0 | 100.0 |
| 3 | 50 | 5.2 | 2 | 1.5 | 0 | 58.7 | 85.2 | 8.9 | 3.4 | 2.6 | 0.0 | 100.0 |
| 4 | 50 | 8 | 2 | 1.5 | 0 | 61.5 | 81.3 | 13.0 | 3.3 | 2.4 | 0.0 | 100.0 |
| 5 | 50 | 0 | 2 | 1.5 | 2 | 55.5 | 90.1 | 0.0 | 3.6 | 2.7 | 3.6 | 100.0 |
| 6 | 50 | 0 | 2 | 1.5 | 2 | 55.5 | 90.1 | 0.0 | 3.6 | 2.7 | 3.6 | 100.0 |
| 7 | 50 | 0 | 2 | 1.5 | 2 | 55.5 | 90.1 | 0.0 | 3.6 | 2.7 | 3.6 | 100.0 |
| 8 | 50 | 0 | 2 | 1.5 | 2 | 55.5 | 90.1 | 0.0 | 3.6 | 2.7 | 3.6 | 100.0 |
| 9 | 50 | 0 | 2 | 1.5 | 1 | 54.5 | 91.7 | 0.0 | 3.7 | 2.8 | 1.8 | 100.0 |
| 10 | 50 | 0 | 2 | 1.5 | 0.5 | 54 | 92.6 | 0.0 | 3.7 | 2.8 | 0.9 | 100.0 |
| 11 | 50 | 0 | 2 | 1.5 | 3.4 | 56.9 | 87.9 | 0.0 | 3.5 | 2.6 | 6.0 | 100.0 |
| 12 | 50 | 0 | 2 | 1.5 | 0 | 53.5 | 93.5 | 0.0 | 3.7 | 2.8 | 0.0 | 100.0 |
| 13 | 50 | 0 | 2 | 1.5 | 0 | 53.5 | 93.5 | 0.0 | 3.7 | 2.8 | 0.0 | 100.0 |
| 14 | 50 | 0.85 | 2 | 1.5 | 0 | 54.35 | 92.0 | 1.6 | 3.7 | 2.8 | 0.0 | 100.0 |
| 15 | 50 | 8 | 2 | 1.5 | 0 | 61.5 | 81.3 | 13.0 | 3.3 | 2.4 | 0.0 | 100.0 |
| 16 | 50 | 0 | 2 | 1.5 | 0 | 53.5 | 93.5 | 0.0 | 3.7 | 2.8 | 0.0 | 100.0 |
| 17 | 50 | 8 | 2 | 1.5 | 0 | 61.5 | 81.3 | 13.0 | 3.3 | 2.4 | 0.0 | 100.0 |
| 18 | 40 | 0 | 2 | 1.5 | 0 | 43.5 | 92.0 | 0.0 | 4.6 | 3.4 | 0.0 | 100.0 |
| 19 | 40 | 0 | 2 | 1.5 | 0 | 43.5 | 92.0 | 0.0 | 4.6 | 3.4 | 0.0 | 100.0 |
| 20 | 50 | 0 | 2 | 1.5 | 0 | 53.5 | 93.5 | 0.0 | 3.7 | 2.8 | 0.0 | 100.0 |
| 21 | 50 | 0 | 2 | 1.5 | 0 | 53.5 | 93.5 | 0.0 | 3.7 | 2.8 | 0.0 | 100.0 |
| 22 | 50 | 0 | 2 | 1.5 | 0 | 53.5 | 93.5 | 0.0 | 3.7 | 2.8 | 0.0 | 100.0 |
| 23 | 30 | 0 | 2 | 1.5 | 0 | 33.5 | 89.6 | 0.0 | 6.0 | 4.5 | 0.0 | 100.0 |
| 24 | 50 | 0 | 2 | 1.5 | 0 | 53.5 | 93.5 | 0.0 | 3.7 | 2.8 | 0.0 | 100.0 |
| 25 | 50 | 0 | 2 | 1.5 | 0 | 53.5 | 93.5 | 0.0 | 3.7 | 2.8 | 0.0 | 100.0 |
| 26 | 42 | 0 | 2 | 1.5 | 0 | 45.5 | 92.3 | 0.0 | 4.4 | 3.3 | 0.0 | 100.0 |
| 27 | 40 | 0 | 2 | 1.5 | 0 | 43.5 | 92.0 | 0.0 | 4.6 | 3.4 | 0.0 | 100.0 |
| 28 | 37 | 0 | 2 | 1.5 | 0 | 40.5 | 91.4 | 0.0 | 4.9 | 3.7 | 0.0 | 100.0 |
| 29 | 36 | 0 | 2 | 1.5 | 0 | 39.5 | 91.1 | 0.0 | 5.1 | 3.8 | 0.0 | 100.0 |
| 30 | 34 | 0 | 2 | 1.5 | 0 | 37.5 | 90.7 | 0.0 | 5.3 | 4.0 | 0.0 | 100.0 |

As shown in Table 1, the resin print compositions in which the torque is 0.085 to 0.315 N·m by the above measurement method when turned into non-volatile components provided a good texture when the resin print (pattern) was formed on the cloth. Also, even after heat pressing, no or little deformation or discoloration was recognized in the resin print. On the other hand, with respect to those having a torque of less than 0.085 N·m, deformation and/or discoloration was seen after heat pressing, though the texture was good after the resin print. Also, with respect to those having a torque exceeding 0.315 N·m, the texture was inferior when the resin print was performed.

With use of a polyester cloth decorated by these resin print compositions, the process of simultaneously performing the PP-molding of the door and the bonding of the decorated sheet was tried, whereby the result corresponding to the overall evaluation was obtained. With respect to those having an overall evaluation of ◯ or ⊙, no conspicuous deformation or discoloration was generated in the resin print. Also, with respect to all of those having an overall evaluation of ◯ or ⊙, no conspicuous adhesiveness was seen between the mold and the resin print, and no roughening was generated on the resin print surface even when the above process was carried out. However, the tendency of decrease in the adhesiveness was seen in the composition to which an inorganic pigment (titanium oxide in the present Example) was added.

### INDUSTRIAL APPLICABILITY

The resin print composition according to the present invention is most suitable for performing a resin print on a cloth that is used in a process to which a high temperature is applied.

What is claimed is:

1. A resin print composition for imparting a pattern to a cloth surface, said resin print composition made of an aqueous dispersion containing a resin selected from the group consisting of an acrylic resin and a urethane resin, wherein a torque is from 0.085 N·m to 0.315 N·m when a twist is applied at 1°/sec for 60 seconds while pressing at 0.35 MPa under a condition of 170° C. after the aqueous dispersion is brought into a solid state by volatilizing volatile components from the aqueous dispersion.

2. The resin print composition according to claim 1, wherein said torque is from 0.17 N·m to 0.25 N·m.

3. The resin print composition according to claim 1, containing a desiccation-preventing agent selected from the group consisting of ethylene glycol, urea, and terpene.

4. The resin print composition according to claim 1, containing a urethane and/or acrylic thickening agent.

5. The resin print composition according to claim 1, wherein a content of said resin in said resin print composition as converted in terms of non-volatile components is 80 wt % to 95 wt %.

6. The resin print composition according to claim 1, wherein said resin is an acrylic resin, and said resin print composition further contains a cross-linking agent.

7. The resin print composition according to claim 1, containing an inorganic pigment.
